(19) United States
(12) Patent Application Publication
(10) Pub. No.: US 2016/0273703 A1
(43) Pub. Date: Sep. 22, 2016

(54) A Clamping Device for a Camera Device

(71) Applicant: WINNERS' SUN PLASTIC ELECTRONIC (SHENZHEN) LIMITED COMPANY, Shenzhen (CN)

(72) Inventor: Zhengliang LI, ShangHai (CN)

(73) Assignee: Winners' Sun Plastic & Electronic (Shenzhen) Limited Company, Shenzhen (CN)

(21) Appl. No.: 14/759,693

(22) PCT Filed: Nov. 12, 2014
(86) PCT No.: PCT/CN2014/090895

§ 371 Date: Jul. 8, 2015

(30) Foreign Application Priority Data
Feb. 20, 2014 (CN) 201420074968.4

(51) Int. Cl. F16M 13/02; A45F 5/00; G03B 17/56; F16B 2/12

(52) U.S. Cl. CPC F16M 13/02; F16B 2/12; A45F 5/00; G03B 17/561; A45F 2200/0533

(57) ABSTRACT

The present application relates to a clamping device for a camera device, including a carrier for carrying the camera device, the carrier including a connecting end and a free end, the connecting end being connected to at least one supporting arm, the supporting arm being provided thereon with a clamping structure that can be stretchable; the clamping device further including a connector connected to the carrier through a hinge structure; the connector being provided thereon with a connecting portion; an upper surface of the carrier being a curved surface; and the clamping structure including a clamping portion, the clamping portion including a clamping curved surface corresponding to the curved surface of the upper surface of the carrier. The camera device is clamped and clasped between the upper surface of the carrier and the clamping curved surface on the clamping portion, so the camera device is not easily slip off. Meanwhile, a connector is arranged under the carrier through a hinge structure. The hinge structure is rotatable. When in use, the clamping device can rotate to a desired angle for photo shooting, and when not in use, the clamping device can rotate to an angle for easy storage.

### FIELD OF THE INVENTION

The present application relates to a photo shooting support device, and more particularly to a clamping device for a camera device.

### BACKGROUND

In real life, when people go to travel somewhere, they usually carry a camera device to take a group photo of friends and relatives with scenic spots or record a video as a souvenir. In order to take a group photo of all the people, generally one person will hold the camera device to take a photo in reverse, that is, to take a selfie. However, since the camera is bulky and inconvenient, taking selfies requires the user to hold the camera at arm-length, and the selfie photo turns out to be blurry because the hands shake and tremble. The photo image quality may not be good. With more people, it is hard to take selfies fitting in everyone's face. Now, a kind of handheld selfie stick device appears on the market. The selfie stick device holds a camera device, such as a smart phone, to the top end of the selfie stick through a clamping device. Since the shooting range can be adjusted by regulating camera-subject distances and angles via the selfie stick, the photo image quality will be improved. However, in the prior art, there are certain defects in clamping the camera device, i.e., the camera device is not held firmly enough and may easily slip off.

### SUMMARY

In order to overcome the aforementioned deficiencies, the present application provides a clamping device for a camera device, so as to hold the camera device firmly enough so that the camera devices will not easily slip off.

The clamping device for a camera device according to the present application includes a carrier for carrying the camera device, the carrier including a connecting end and a free end, the connecting end being provided with at least one supporting arm, the supporting arm being provided thereon with a clamping structure that can be stretchable; the clamping device further includes a connector connected to the carrier through a hinge structure, the connector being provided thereon with a connecting portion; an upper surface of the carrier being a curved surface; and the clamping structure including a clamping portion, the clamping portion including a clamping curved surface corresponding to the curved surface of the upper surface of the carrier.

In one embodiment, the connecting portion is an inner hole arranged in the connector.

In one embodiment, the inner hole is an internal thread hole.

In one embodiment, the clamping structure further includes a handle, and the clamping portion is integrally arranged at a lower end of the handle.

In one embodiment, there are two supporting arms. The clamping structure further includes a movable rod, the movable rod is folded to an inverted U-shape; two legs of the inverted U-shaped movable rod are respectively stretchably inserted into the two supporting arms, and the middle portion of the inverted U-shaped movable rod is provided with a bending structure; the bending structure is arranged above the carrier.

In one embodiment, a recess is arranged on the handle, and the handle is wedged into the bending structure of the movable rod through the recess, so that the handle is arranged on the movable rod.

In one embodiment, an elastic element is arranged between the movable rod and the supporting arms.

In one embodiment, the hinge structure is located below the free end of the carrier, and the hinge structure is provided thereon with a locking device.

In one embodiment, the curved surface of the upper surface of the carrier and the clamping curved surface of the clamping portion are both provided thereon with concavo-convex marks.

In one embodiment, the free end of the carrier is higher than the connecting end of the carrier.

The beneficial effects of the present application are as follows. The camera device is held and clamped through the cooperation of the clamping structure and the carrier. The curved surface of the upper surface of the carrier and the clamping curved surface on the clamping portion form a clasping structure, which can make the camera device better clasped between the two curved surfaces and not easily slip off. Meanwhile, a connector is arranged below the carrier through a hinge structure, so that the carrier can be connected to other support structures or other handheld structures through the connector, so as to achieve the selfie function; on the other hand, the hinge structure is rotatable. When in use, the clamping device can rotate to a desired angle for photo shooting, and when not in use, the connector can rotate to an angle for easy storage.

### BRIEF DESCRIPTION OF THE DRAWINGS

The present application will be further described below with reference to the accompany drawings and embodiments, and wherein:

FIG. 1 is an exploded schematic structural view of a clamping device according to the present application;

FIG. 2 is a three-dimensional schematic structural view of the clamping device according to the present application;

FIG. 3 is a side view of the clamping device according to the present application; and

FIG. 4 is a schematic view illustrating an operation of the present application.

### DETAILED DESCRIPTION

A preferred embodiment of the present application is now described in detail with reference to the accompanying drawings.

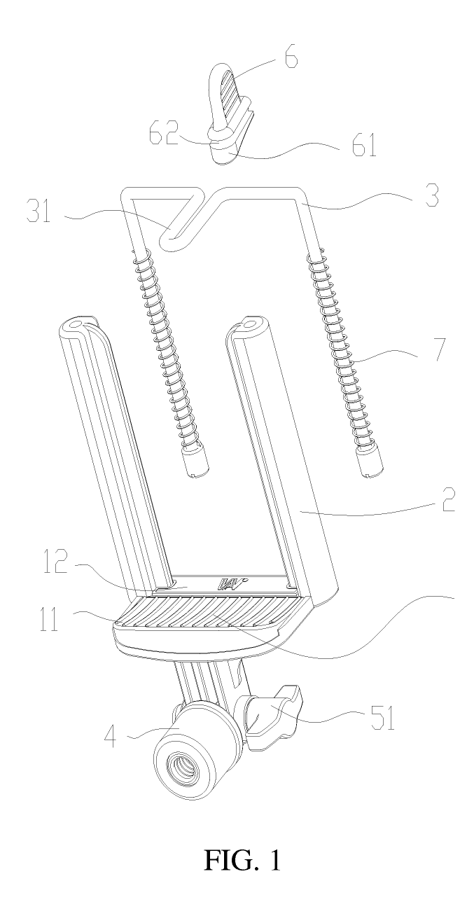

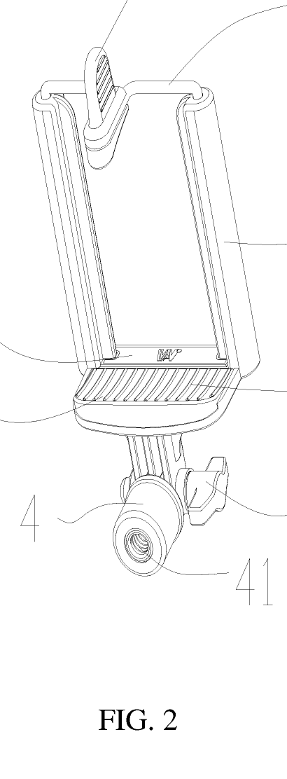

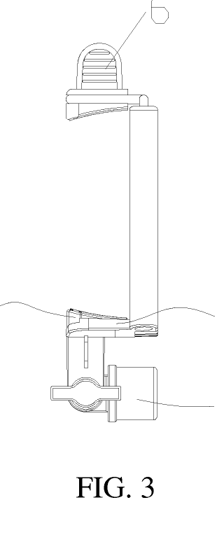

As shown in FIG. 1, FIG. 2 and FIG. 3, an embodiment of the present application provides a clamping device for a camera device of a handheld photo shooting remote control device. The clamping device includes a carrier 1 for carrying the camera device. The carrier 1 has a connecting end 12 and a free end 11. The connecting end 12 is connected to at least one supporting arm 2. And the supporting arm 2 is provided thereon with a clamping structure that can be stretchable. In this embodiment, the camera device is held and clamped through the cooperation of the clamping structure and the carrier. A connector 4 is connected to the carrier 1 through a hinge structure 5. The connector 4 is provided thereon with a connecting portion. A handle-type remote control can be directly connected to the clamping device through the connecting portion of the connector 4. And the clamping device may also be connected to a tripod, or a telescopic stick, or other handheld structures, or other support structures through the connecting portion, so as to achieve the selfie function in a remote control manner.

As shown in FIG. 1 and FIG. 2, in one embodiment, the connecting portion of the connector 4 is an inner hole 41 arranged in the connector 4, which is preferably an internal threaded hole. And it is feasible to arrange outer threads on a structure connected therewith for mutual threaded connections. In another embodiment, an engagement structure is arranged for an engaged connection between the connecting portion of the connector 4 and the structure connected therewith. Of course, such details of the connection are merely examples, and claimed subject matter is not so limited.

As shown in FIG. 1 to FIG. 3, an upper surface of the carrier 1 in this embodiment is a curved surface. The clamping structure includes a handle 6 and a clamping portion 61. The clamping portion 61 is integrally arranged at the lower end of the handle 6. The clamping portion 61 includes a clamping curved surface corresponding to the curved surface of the upper surface of the carrier 1. And in this embodiment, the curved surface of the upper surface of the carrier 1 and the clamping curved surface on the clamping portion 61 form a clasping structure, which can make the camera device better clasped between the two curved surfaces and not easily slip off. A further preferred manner of this embodiment is that, the free end 11 of the carrier 1 is higher than the connecting end 12, as shown in FIG. 3. The structure of the clamping portion 61 corresponds to the structure of the carrier 1, that is, an angle between the support arm 2 and the upper surface of the carrier 1 and an angle between the support arm 2 and the lower surface of the handle 6 are both less than 90 degrees, so that the camera device held to the carrier 1 through the clamping structure will not easily slip off, and the camera device is more stably and firmly clasped in the clamping device.

As shown in FIG. 1 and FIG. 2, there are two support arms 2. The clamping structure further includes a movable rod 3. The movable rod 3 is folded to an inverted U-shape. Two legs of the inverted U-shaped movable rod are respectively stretchably inserted into the two supporting arms 2. The middle portion of the inverted U-shaped movable rod is provided with a bending structure 31. The bending structure 31 and two legs constitute the one-piece integrally-formed movable rod 3. The bending structure 31 is arranged above the carrier 1. Between the movable rod 3 and the supporting arms 2 is an elastic element 7. Furthermore, the elastic element 7 and two legs of the inverted U-shaped movable rod 3 are arranged in inner cavities of the supporting arms 2, and two ends of the elastic element 7 respectively abut against the end of movable rod 3 and the end of the supporting arm 2, as shown in FIG. 1. Therefore, the movable rod 3, the supporting arms 2 and the elastic element 7 form a stretchable mechanism. The elastic device 7 is preferably a spring.

As shown in FIG. 1, the handle 6 is provided thereon with a recess 62. The handle 6, the recess 62 and the clamping portion 61 are one-piece integrally-formed. The handle 6 is wedged into the bending structure 31 of the movable rod 3 through the recess 62. Furthermore, the bending structure 31 is arranged in the middle portion of the movable rod 3 and located above the carrier 1, and when the handle 6 is wedged and clipped by the bending structure 31 of the movable rod 3 through the recess 62, the lower surface of the clamping portion 61 of the handle 6 is opposite the carrier 1.

As shown in FIG. 2 and FIG. 3, the hinge structure 5 is arranged below the free end 11. And the connector 4 is connected with the free end 11 through the hinge structure 5. The hinge structure 5 is provided thereon with a locking device 51. The locking device 1 is not only used to lock the connector 4 and the free end 11, but also serves as a rotating shaft between the connector 4 and the free end 11. When taking photos or taking selfies, the photo shooting angle of the camera device can be adjusted due to setting a hinge structure between the connector 4 and the free end 11 of the carrier 1, so as to achieve a better image quality. The connector 4 can be directly connected to a handle-type remote control through the connecting portion. And the connecting portion is used to connect peripherals, such as a tripod, or a telescopic stick and the like. When the connector 4 rotates around the shaft to the rightmost position shown in FIG. 3, its end face is aligned with or not beyond an end face of the connecting end 12. Such alignment design saves space for easy storage and easy to carry. Concavo-convex marks, such as concavo-convex stripes or concavo-convex points, are provided on the upper surface of carrier 1 and on the lower surface of the clamping portion 61 to increase friction between the clamping device and the camera device when the camera device is held and clamped between the carrier 1 and the handle 6, so that the camera device will not easily slip off.

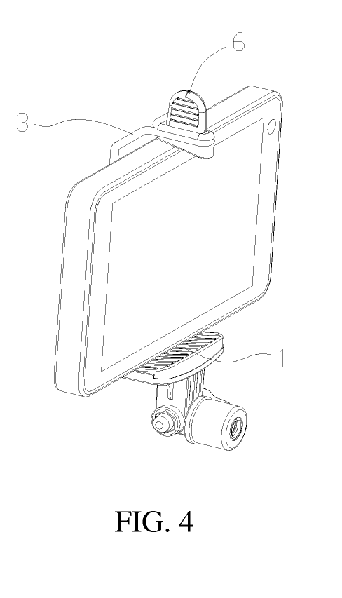

FIG. 4 is a schematic view illustrating an operation of the present application. When in use, the handle 6 is manually pulled upwards to drive the movable rod 3 to move upwards, causing the distance between the carrier 1 and the lower surface of the clamping portion 61 of the handle 6 to increase. When the distance is greater than the size of the camera device, the camera device is placed on the carrier 1. After the movable rod 3 is loosened, the elastic element 7 between the movable rod 3 and the supporting arms 2 drives the movable rod 3 to move downwards, so as to clamp the camera device.

It should be understood that, the above embodiment is only intended to describe the technical solution of the present application, instead of making limitations thereto. Those skilled in the art can make amendments to the technical solution disclosed in the above embodiment, or make equivalent replacements to some technical features therein; and all the amendments and replacements should fall within the scope of the appended claims of the present application.

1. A clamping device for a camera device, comprising an carrier for carrying the camera device, the carrier comprising a connecting end and a free end, the connecting end being connected to at least one supporting arm, and the supporting arm being provided thereon with a clamping structure that can be stretchable, The clamping device further comprising: a connector connected to the carrier through a hinge structure, the connector being provided thereon with a connecting portion; an upper surface of the carrier being a curved surface; and the clamping structure comprising a clamping portion, the clamping portion comprising a clamping curved surface corresponding to the curved surface of the upper surface of the carrier.

2. The clamping device according to claim 1, wherein the connecting portion is an inner hole arranged in the connector.

3. The clamping device according to claim 2, wherein the inner hole is an internal thread hole.

4. The clamping device according to claim 2, wherein the clamping structure further comprises a handle, and the clamping portion is integrally arranged at the lower end of the handle.

5. The clamping device according to claim 4, wherein there are two support arms, the clamping structure further comprises a movable rod; the movable rod is folded to an inverted U-shape; two legs of the inverted U-shaped movable rod are respectively stretchably inserted into the two supporting arms, and the middle portion of the inverted U-shaped movable rod is provided with a bending structure; the bending structure is arranged above the carrier.

6. The clamping device according to claim 5, wherein a recess is arranged on the handle; the handle is wedged into the bending structure of the movable rod through the recess, so that the handle is arranged on the movable rod.

7. The clamping device according to claim 5, wherein an elastic element is arranged between the movable rod and the supporting arm.

8. The clamping device according to claim 1, wherein the hinge structure is located below the free end of the carrier, and the hinge structure is provided thereon with a locking device.

9. The clamping device according to claim 1, wherein the curved surface of the upper surface of the carrier and the clamping curved surface of the clamping portion are both provided thereon with concavo-convex marks.

10. The clamping device according to claim 4, wherein the free end of the carrier is higher than the connecting end of the carrier.
